(19) United States
(12) Patent Application Publication
(10) Pub. No.: US 2016/0323179 A1
(43) Pub. Date: Nov. 3, 2016

(54) BNG SUBSCRIBERS INTER-CHASSIS REDUNDANCY USING MC-LAG

(71) Applicant: Telefonaktiebolaget L M Ericsson (publ), Stockholm (SE)

(72) Inventors: Sunny Wang, Saratoga, CA (US); Satyanarayana Madem, San Jose, CA (US); Juan Lu, Sunnyvale, CA (US)

(21) Appl. No.: 14/700,033

(22) Filed: Apr. 29, 2015

(51) Int. Cl. H04L 12/703; H04L 29/08

(52) U.S. Cl. CPC H04L 45/28; H04L 67/141

(57) ABSTRACT

Exemplary methods in a first network device of an inter-chassis redundancy (ICR) system communicatively coupled to a second network device of the ICR system, the first network device configured as an active ICR device communicatively coupled to a third network device via a first link and a third link, the second network device configured as a standby ICR device, wherein the first link and the second link belong to a first multi-chassis link aggregation group (MC-LAG), include negotiating with a first client device to create a first session that is carried over the first link of the first MC-LAG, determining whether the first session is stateful, wherein a session is stateful if it is carried over an MC-LAG, and in response to determining the first session is stateful, sending session information associated with the first session to the second network device.

### FIELD

Embodiments of the invention relate to the field of packet networks, and more specifically, to inter-chassis redundancy (ICR) using multi-chassis link aggregation group (MC-LAG).

### BACKGROUND

In communication networks, it is generally desirable to prevent service outages and/or loss of network traffic. By way of example, such service outages and/or loss of network traffic may occur when a network device fails, loses power, is taken offline, is rebooted, a communication link to the network device breaks, etc. In order to prevent such service outages and/or loss of network traffic, the communication networks may utilize inter-chassis redundancy (ICR). In an ICR system, there are typically two ICR devices (i.e., nodes). During normal operation, one ICR device is configured to be in active state while the other is configured to be in standby state. The active ICR device is responsible for handling network traffic with a plurality other network devices. When a failure is detected, the ICR devices switch roles, and the standby ICR device becomes the active ICR device, and takes over the responsibility of handling network traffic.

In order to reduce the switchover time, session information of existing subscriber sessions must be synced from the active ICR device to the standby ICR device. A conventional system for managing subscriber sessions (such as the virtual subscriber management system described in the patent application EP20110004989, which is hereby incorporated by reference) includes one control and management virtual chassis that manages subscriber sessions in two physical chassis. Such a conventional architecture results in several drawbacks. For example, since the conventional architecture uses one virtual chassis, it needs to maintain all subscriber session information in the virtual system on both physical chassis. As a result, the conventional architecture cannot support both subscribers that require stateful ICR protection and subscribers that do not require the expensive ICR protection at the same time. Further, the conventional architecture does not support/work with MC-LAG.

### SUMMARY

Exemplary methods performed by a first network device of an inter-chassis redundancy (ICR) system that is communicatively coupled to a second network device of the ICR system, wherein the first network device configured to serve as an active ICR device of the ICR system is communicatively coupled to a third network device via a first link and a third link, and wherein the second network device configured to serve as a standby ICR device of the ICR system is communicatively coupled to the third network device via a second link, wherein the first link and the second link belong to a first multi-chassis link aggregation group (MC-LAG), and wherein the third network device is communicatively coupled to a plurality of client devices, include negotiating with a first client device of the plurality of client devices to create a first session that is carried over the first link associated with the first MC-LAG. The methods further include determining whether the first session is stateful, wherein a session is stateful if it is carried over an MC-LAG, and in response to determining the first session is stateful, sending session information associated with the first session to the second network device, causing the second network device to use the session information to create a standby session corresponding to the first session.

In one embodiment, the methods further include negotiating with a second client device of the plurality of client devices to create a second session that is carried over the third link, and in response to determining the second session is not stateful, using the second session to carry traffic without sending session information associated with the second session to the second network device.

In one embodiment, the methods further include detecting a failure that prevents the first session to carry traffic over the first link of the first MC-LAG. The methods further include in response to detecting the failure, performing the ICR switchover by transitioning to serving as the standby ICR device of the ICR system, and sending a notification of the ICR switchover to the second network device, causing the second network device to transition to serving as the active ICR device of the ICR system, and further causing the second network device to activate the standby session and use the activated session to carry traffic without having to negotiate with the first client device.

In one embodiment, sending the session information associated with the first session to the second network device comprises storing the session information associated with the first session in a distributed database system (DDS), wherein the DDS is configured to provide an indication, wherein the indication comprises of at least one of an indication that the session information has been sent to a peer ICR device, an indication that the session information has been received by a DDS at the peer ICR device, and an indication that the session information has been sent by the DDS at the peer device to a session daemon at the peer ICR device.

Exemplary methods performed by a first network device of an inter-chassis redundancy (ICR) system that is communicatively coupled to a second network device of the ICR system, wherein the first network device configured to serve as a standby ICR device of the ICR system is communicatively coupled to a third network device via a second link, and wherein the second network device configured to serve as an active ICR device of the ICR system is communicatively coupled to the third network device via a first link, wherein the first link and the second link belong to a first multi-chassis link aggregation group (MC-LAG), and wherein the third network device is communicatively coupled to a plurality of client devices, include receiving from the second network device session information associated with a first session, wherein the first session is used by the second network device for exchanging traffic with a first client device of the plurality of client devices, and using the received session information to create a standby session corresponding to the first session.

In one embodiment, the methods further include receiving a notification from the second network device indicating the second network device has performed an ICR switchover. The methods further include in response to receiving the notification, performing an ICR switch over by transitioning to serving as the active ICR device of the ICR system, activating the standby session, and using the activated standby session to carry traffic without having to negotiate with the first client device.

In one embodiment, the methods further include storing the received session information associated with the first session in a distributed database system (DDS), wherein the DDS is configured to provide an indication, wherein the indication comprises of at least one of an indication that the session information has been received and an indication that session information has been sent to a session daemon at the first network device.

### BRIEF DESCRIPTION OF THE DRAWINGS

The invention may best be understood by referring to the following description and accompanying drawings that are used to illustrate embodiments of the invention. In the drawings:

FIG. 1-A is a block diagram illustrating a network according to one embodiment.

FIG. 1-B is a block diagram illustrating a network according to one embodiment.

FIG. 2 is a transaction diagram illustrating operations/transactions for performing fast switchover at an ICR system using MC-LAG according to one embodiment.

FIG. 3 is a flow diagram illustrating a method for performing fast switchover at an ICR system using MC-LAG according to one embodiment.

FIG. 4 is a flow diagram illustrating a method for performing fast switchover at an ICR system using MC-LAG according to one embodiment.

FIG. 5A illustrates connectivity between network devices (NDs) within an exemplary network, as well as three exemplary implementations of the NDs, according to some embodiments of the invention.

FIG. 5B illustrates an exemplary way to implement a special-purpose network device according to some embodiments of the invention.

FIG. 5C illustrates various exemplary ways in which virtual network elements (VNEs) may be coupled according to some embodiments of the invention.

FIG. 5D illustrates a network with a single network element (NE) on each of the NDs, and within this straight forward approach contrasts a traditional distributed approach (commonly used by traditional routers) with a centralized approach for maintaining reachability and forwarding information (also called network control), according to some embodiments of the invention.

FIG. 5E illustrates the simple case of where each of the NDs implements a single NE, but a centralized control plane has abstracted multiple of the NEs in different NDs into (to represent) a single NE in one of the virtual network(s), according to some embodiments of the invention.

FIG. 5F illustrates a case where multiple VNEs are implemented on different NDs and are coupled to each other, and where a centralized control plane has abstracted these multiple VNEs such that they appear as a single VNE within one of the virtual networks, according to some embodiments of the invention.

FIG. 6 illustrates a general purpose control plane device with centralized control plane (CCP) software), according to some embodiments of the invention.

### DESCRIPTION OF EMBODIMENTS

The following description describes methods and apparatus for performing inter-chassis redundancy (ICR) switchover. In the following description, numerous specific details such as logic implementations, opcodes, means to specify operands, resource partitioning/sharing/duplication implementations, types and interrelationships of system components, and logic partitioning/integration choices are set forth in order to provide a more thorough understanding of the present invention. It will be appreciated, however, by one skilled in the art that the invention may be practiced without such specific details. In other instances, control structures, gate level circuits and full software instruction sequences have not been shown in detail in order not to obscure the invention. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Bracketed text and blocks with dashed borders (e.g., large dashes, small dashes, dot-dash, and dots) may be used herein to illustrate optional operations that add additional features to embodiments of the invention. However, such notation should not be taken to mean that these are the only options or optional operations, and/or that blocks with solid borders are not optional in certain embodiments of the invention.

In the following description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other.

An electronic device stores and transmits (internally and/or with other electronic devices over a network) code (which is composed of software instructions and which is sometimes referred to as computer program code or a computer program) and/or data using machine-readable media (also called computer-readable media), such as machine-readable storage media (e.g., magnetic disks, optical disks, read only memory (ROM), flash memory devices, phase change memory) and machine-readable transmission media (also called a carrier) (e.g., electrical, optical, radio, acoustical or other form of propagated signals—such as carrier waves, infrared signals). Thus, an electronic device (e.g., a computer) includes hardware and software, such as a set of one or more processors coupled to one or more machine-readable storage media to store code for execution on the set of processors and/or to store data. For instance, an electronic device may include non-volatile memory containing the code since the non-volatile memory can persist code/data even when the electronic device is turned off (when power is removed), and while the electronic device is turned on that part of the code that is to be executed by the processor(s) of that electronic device is typically copied from the slower non-volatile memory into volatile memory (e.g., dynamic random access memory (DRAM), static random access memory (SRAM)) of that electronic device. Typical electronic devices also include a set or one or more physical network interface(s) to establish network connections (to transmit and/or receive code and/or data using propagating signals) with other electronic devices. One or more parts of an embodiment of the invention may be implemented using different combinations of software, firmware, and/or hardware.

A network device (ND) is an electronic device that communicatively interconnects other electronic devices on the network (e.g., other network devices, end-user devices). Some network devices are “multiple services network devices” that provide support for multiple networking functions (e.g., routing, bridging, switching, Layer 2 aggregation, session border control, Quality of Service, and/or subscriber management), and/or provide support for multiple application services (e.g., data, voice, and video).

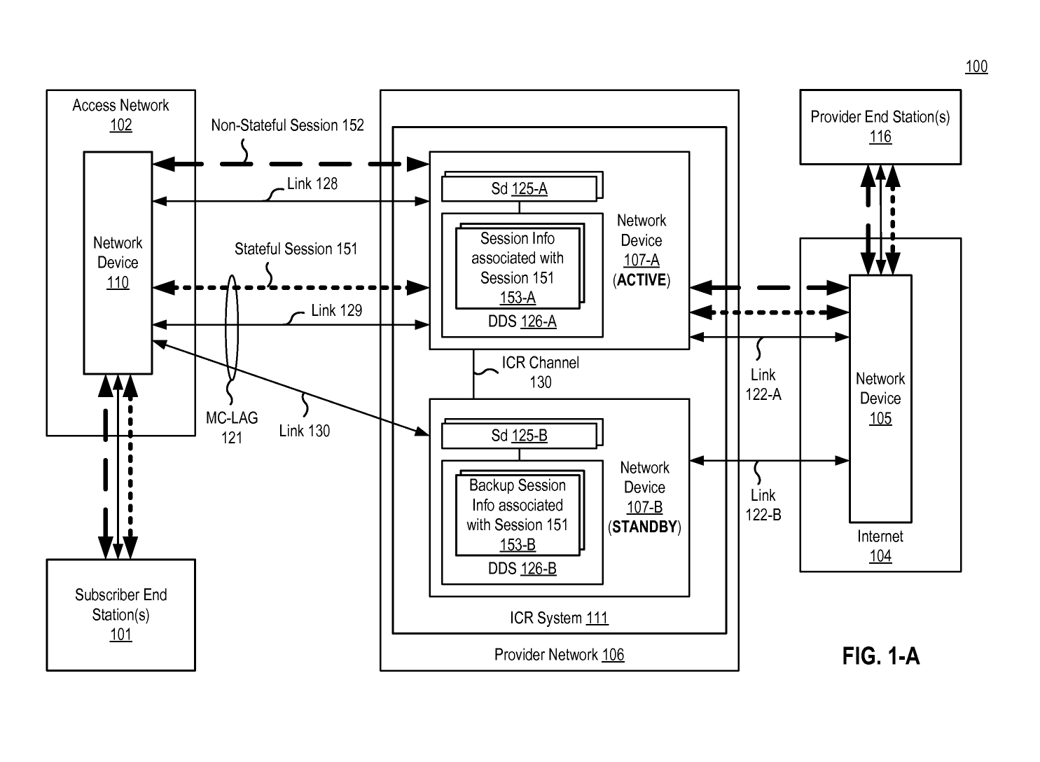

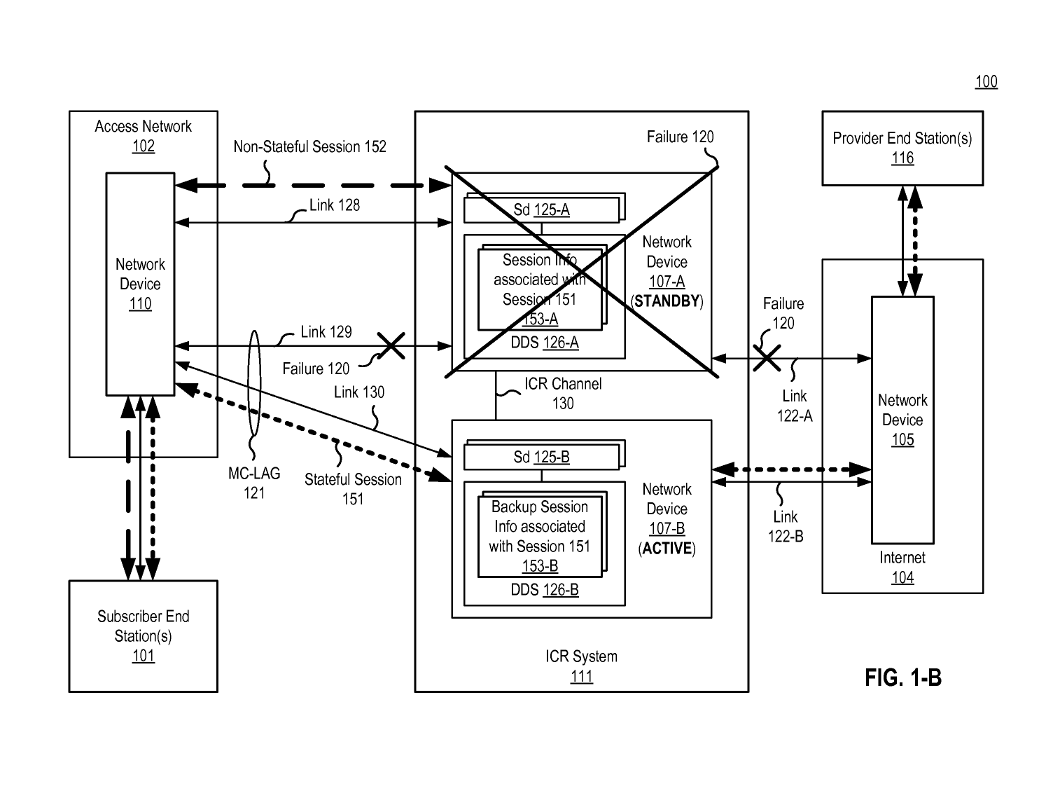

FIGS. 1-A and 1-B are block diagrams illustrating a network according to one embodiment. Referring first to FIG. 1-A, network 100 includes, but is not limited to, one or more subscriber end stations 101. Throughout the description, subscriber end stations are also referred to as “client devices”. Examples of suitable subscriber end stations include, but are not limited to, servers, workstations, laptops, netbooks, palm tops, mobile phones, smartphones, multimedia phones, tablets, phablets, Voice Over Internet Protocol (VOIP) phones, user equipment, terminals, portable media players, GPS units, gaming systems, set-top boxes, and combinations thereof. Subscriber end stations 101 access content/services provided over the Internet and/or content/services provided on virtual private networks (VPNs) overlaid on (e.g., tunneled through) the Internet. The content and/or services are typically provided by one or more provider end stations 116 (e.g., server end stations) belonging to a service or content provider. Examples of such content and/or services include, but are not limited to, public webpages (e.g., free content, store fronts, search services), private webpages (e.g., username/password accessed webpages providing email services), and/or corporate networks over VPNs, etc.

As illustrated, subscriber end stations 101 are communicatively coupled (e.g., through customer premise equipment) to access network devices (e.g., network device 110) of access network 102 (wired and/or wirelessly). Access network devices can be communicatively coupled to provider edge network devices (e.g., network devices 107A and 107-B) of provider edge network 106. The provider edge network devices may be communicatively coupled through Internet 104 (e.g., through one or more core network devices 105) to one or more provider end stations 116 (e.g., server end stations). In some cases, the provider edge network devices of provider edge network 106 may host on the order of thousands to millions of wire line type and/or wireless subscriber end stations, although the scope of the invention is not limited to any known number.

In one embodiment, network devices 107-A and 107-B form inter-chassis redundancy (ICR) system/cluster 111. In an ICR system, there are typically two ICR devices. There may, however, be more than two ICR devices in an ICR system. During normal operation, one ICR device is configured to be in active state (herein referred to as an active ICR device) while the other is configured to be in standby state (herein referred to as a standby ICR device). The active ICR device is responsible for handling network traffic with a plurality other network devices (e.g., subscriber end stations 101), including, for example, allocating Internet Protocol (IP) addresses to such subscriber end stations. During an ICR switchover (herein referred to simply as a “switchover”), the active and standby ICR devices switch roles (e.g., the active ICR device becomes the standby ICR device, and the standby ICR device becomes the active ICR device.) FIG. 1-A illustrates that network devices 107-A and 107-B are configured to serve as the active and standby ICR device of ICR system 111, respectively.

Subscriber end stations 101 and provider end stations 116 may exchange traffic via the active ICR device of ICR system 111 using one or more sessions that have been negotiated between the active ICR device and subscriber end stations 101. As used herein, a “session” refers to a semi-permanent interactive information exchange (also commonly referred to as a “dialogue”, a “conversation”, etc.) between two or more communicating network devices. The network devices typically negotiate with each other using protocols such as the Point-to-Point (PPP) protocol, the PPP over Ethernet (PPPoE), Dynamic Host Configuration Protocol (DHCP), etc., to create the sessions.

According to one embodiment, each ICR device of ICR system 111 includes one or more session daemons (Sds), wherein each Sd is configured to negotiate with client devices 101 to set up one or more sessions. In the illustrated example, network devices 107-A and 107-B include Sds 125-A and 125-B, respectively. As shown, Sd 125-A has successfully negotiated with client devices 101 and created sessions 151-152 (shown as small dashed lines and large dashed lines, respectively). Session 151 is to be carried over link 129 and session 152 is to be carried over link 128. It should be noted that links 129-130 belong to multi-chassis link aggregation group (MC-LAG) 121. A “LAG” comprises multiple links directly connecting two network devices with multiple, and a load distribution decision across these different link paths is performed at the network device forwarding plane. A “MC-LAG” refers to a LAG that directly connects one network device with two or more other network devices. In the illustrated example, MC-LAG 121 directly connects network device 110 with network devices 107-A and 107-B, via links 129 and 130, respectively.

Each active ICR device maintains session information/records and ICR related resources that are required for handling network traffic with the end stations. Depending on the type of session, the session information may include, but are not limited to: 1) session identifiers (IDs), 2) Internet Protocol (IP) addresses that have been assigned to the subscriber end stations, 3) the Quality of Service (QoS), 4) Access Control List (ACL) that are associated with the subscriber end stations, 5) subscriber circuit counters, and/or 6) Address Resolution Protocol (ARP) and/or Neighbor Discovery (ND) media access controller (MAC) addresses. It should be noted that session timers and session accounting are not performed for the standby sessions.

In order for a standby ICR device to seamlessly handle network connections with the end stations after a switchover event, the session information and the ICR related resources must be synced from the active to standby ICR device. Conventionally, the “all or nothing” approach is taken when session information are synced. In other words, either the session information of all or none of the sessions are synced from the active ICR device to the standby ICR device. Syncing session information of all sessions allows for a faster switchover because the standby ICR device can use the synced session information to create the sessions, without having to negotiate with the end stations. The drawback, however, is that this approach can require a substantial amount of resources to backup all the session information at the standby ICR device. Syncing none of the session information allows for a minimum utilization of resources. The drawback, however, is that this approach results in a slower switchover because the standby ICR device is required to negotiate with each client device in order to create the sessions.

Embodiments of the present Sds overcome the above limitations by only syncing session information of stateful sessions. According to one embodiment, a Sd determines that a session is “stateful” if it is carried over an MC-LAG (as opposed to a link or a LAG that is not protected through the use of multiple chassis). According to one embodiment, a Sd determines that a session is carried over a MC-LAG based on link configuration and information provided by the line card. For example, when a line card receives a packet belonging to a session, the line card presents (i.e., forwards) the packet to the control card to be processed by a Sd. Along with the packet, the line card provides information such as which port/link the packet was received on. Further, each port/link may be associated with a set of configuration (e.g., programmed by a system administrator via a CLI) indicating whether the port/link is part of a MC-LAG. Based on the port/link information and the configuration information, each Sd is able to determine whether the session is part of a MC-LAG. In one embodiment, each Sd of the active ICR device is to store the relevant session information (such as those described above) of each stateful session in a local distributed database system (DDS). The local DDS is configured to sync (i.e., send/transfer) the session information stored therein to a DDS of a peer standby ICR device. The Sds at the standby ICR device is to use the received session information to create standby sessions, each standby session corresponding to an active session at the active ICR device. In this way, when a switchover occurs, the standby ICR device can activate the standby sessions and use the activated sessions to carry traffic, without having to negotiate with the client devices, thereby reducing the traffic/service interruption to the subscriber end station.

In the illustrated example, Sd 125-A has determined that session 151 is stateful because it is carried over MC-LAG 121. Responsive to such a determination, Sd 125-A stores the session information associated with session 151 in DDS 126-A as part of session info 153-A. DDS 126-A, in one embodiment, sends session info 153-A to DDS 126-B via ICR channel 130. Received session info 153-A is stored as session info 153-B in DDS 126-B. In one embodiment, in response to determining session info 153-B has been stored in DDS 126-B, Sd 125-B uses the session information stored as part of session info 153-B to create a standby session corresponding to session 151. In this way, when a switchover occurs and network device 107-B becomes the active ICR device, network device 107-B can simply activate the standby session and use the activated session to carry traffic, without having to negotiate with subscriber end station 101, resulting in minimal or no service interruption to the subscriber end stations. It should be noted that Sd 125-A does not store the session information associated with session 152 because session 152 is not stateful (i.e., it is not carried over an MC-LAG).

Referring now to FIG. 1-B. Network 100 of FIG. 1-B is similar to network 100 of FIG. 1-A. For the sake of brevity, the topology of network 100 shown in FIG. 1-B shall not be described here. The difference, however, is that failure 120 has occurred in network 100 of FIG. 1-B. Failure 120 can be any type of failure that prevents traffic from being carried over link 129 of MC-LAG 121. For example, failure 120 may be a failure of a port, link, line card, and/or chassis.

According to one embodiment, there are two mechanisms that ICR peers can determine that a switchover is to be performed. For example, in the case where failure 120 is a port, link, and/or line card failure, network device 107-A performs a switchover by transitioning to serving as the standby ICR device, and sending a notification to network device 107-B via ICR channel 130 indicating that network device 107-A has transitioned or is in the process of transitioning to serving as the standby ICR device. In the case where failure 120 is a chassis failure (e.g., network device 107-A has failed), network device 107-B detects the switchover in response to not receiving keep alive messages from network device 107-A. In response to determining a switchover is to be performed (based on either a notification from network device 107-A or a failure to receive keep alive messages from network device 107-A), network device 107-B performs a switchover by transitioning to serving as the active ICR device. In one embodiment, network device 107-B also activates the standby sessions that it had created using the backup session information (such as session info 153-B) stored in DDS 126-B.

As part of the switchover, network device 107-A also negotiates with network device 110 (e.g., using the Link Aggregation Control Protocol (LACP) protocol) to stop forwarding traffic towards network device 107-A via link 129. Network device 107-A can perform such LACP negotiation with network device 110, for example, via another link (not shown) that communicatively couples the two network devices. Similarly, network device 107-B also negotiates with network device 110 (e.g., using the LACP protocol) to start forwarding traffic towards network device 107-B via link 130. It should be noted that in the case of a chassis failure, network device 107-A is not able to perform LACP negotiation with network device 110. In such an embodiment, traffic from network device 110 is redirected to network device 107-B based on the LACP negotiation performed between network devices 107-B and 110. Thus, after the switchover is completed, session 151 is carried over link 130 of MC-Lag 121.

Typically, a network device, such as network device 107-A and/or 107-B, includes a set of one or more line cards, a set of one or more control cards, and optionally a set of one or more service cards (sometimes referred to as resource cards). These cards are coupled together through one or more mechanisms (e.g., a first full mesh coupling the line cards and a second full mesh coupling all of the cards). The set of line cards make up the data plane, while the set of control cards provide the control plane and exchange packets with external network devices through the line cards. The set of service cards can provide specialized processing (e.g., Layer 4 to Layer 7 services (e.g., firewall, Internet Protocol Security (IPSec), Intrusion Detection System (IDS), Peer-to-Peer (P2P)), Voice over IP (VoIP) Session Border Controller, Mobile Wireless Gateways (e.g., Gateway General Packet Radio Service (GPRS) Support Node (GGSN), Evolved Packet System (EPS) Gateway)). By way of example, a service card may be used to terminate IPSec tunnels and execute the attendant authentication and encryption algorithms.

According to one embodiment, the various modules (e.g., the session daemon(s) and the DDS) of network device 107-A can be implemented as part of one network device. In an alternative embodiment, these various modules can be implemented as virtual machines that are executed on one or more network devices. In such an embodiment, the various virtualized modules that are distributed among different network devices communicate with other using tunneling mechanisms (e.g., Virtual Extensible LAN (VxLAN)). Virtual machines are described in further details below. Similarly, the various modules of network device 107-B can be implemented as one network device, or distributed among multiple network devices as virtual machines. Embodiments of the present invention shall now be described in greater details through the description of various other figures below.

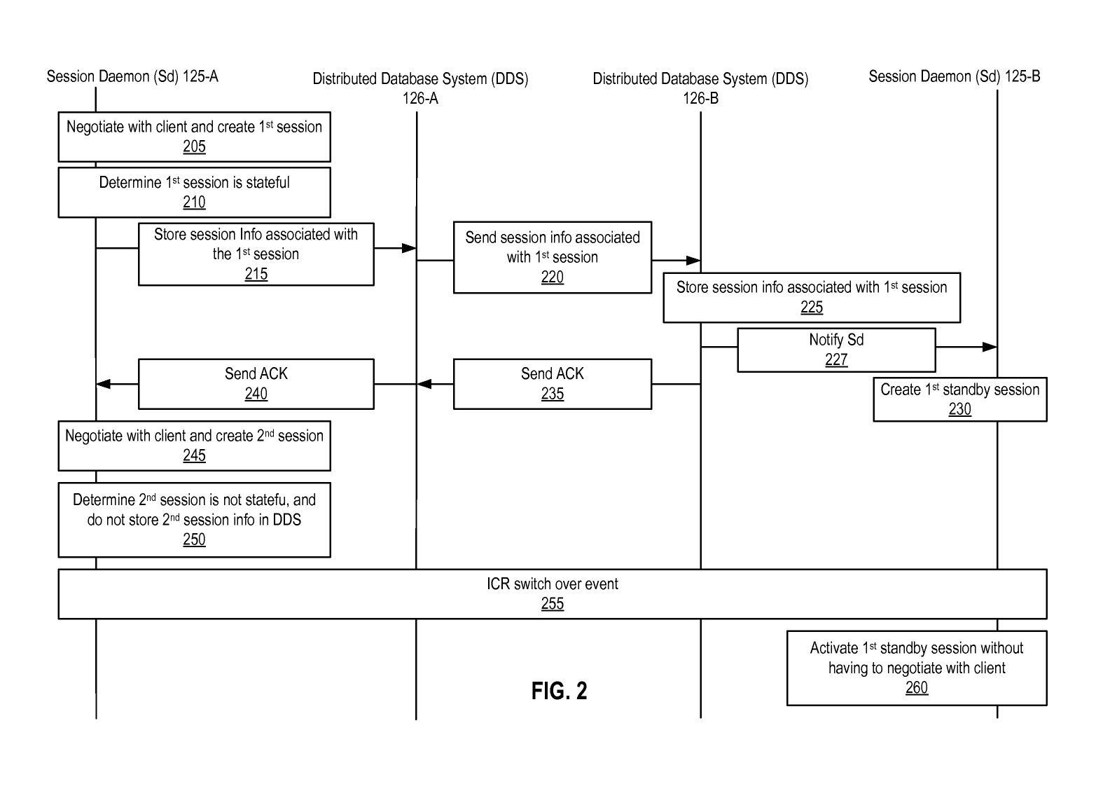

FIG. 2 is a transaction diagram illustrating operations and transactions for performing fast switchover at an ICR system using MC-LAG according to one embodiment. The transactions and operations of FIG. 2 assume a network topology similar to the network topology illustrated in FIGS. 1-A and 1-B.

Referring now to FIG. 2, at operation 205, Sd 125-A negotiates with a client device (e.g., client device 101) and creates a first session (e.g., session 151). At operation 210, Sd 125-A determines that the first session is stateful. For example, Sd 125-A determines that session 151 is stateful because it is carried over MC-LAG 121. At transaction 215, Sd 125-A stores session information associated with the first session in DDS 126-A. For example, Sd 125-A stores session info 153-A in DDS 126-A as session info 153-B.

At transaction 220, DDS 126-A, in response to determining session information has been stored, sends the stored session information associated with the first session to DDS 126-B. At transaction 225, DDS 126-B stores the received session information associated with the first session. At operation 227, DDS 126-B notifies Sd 125-B that a new session info has been stored in the DDS. At operation 230, Sd 125-B uses the stored session information associated with the first session to create a first standby session corresponding to the first session created by Sd 125-A. In this way, when a switchover occurs, network device 107-B can simply activate the first standby session and use the activated session to carry traffic, without having to negotiate with the client, and thereby reducing traffic/service interruption to the subscriber end stations.

At transaction 235, DDS 126-B sends an acknowledgement (ACK) to DDS 126-A. In one embodiment, DDS 126-B is configured to send the ACK: 1) upon receiving the session information, 2) upon storing the session information, 3) upon sending the stored session information to Sd 125-B, and/or 4) upon Sd 125-B completing the creation of the first standby session using the session information.

At transaction 240, DDS 126-A sends an ACK to Sd 125-A. In one embodiment, DDS 126-A is configured to send the ACK: 1) upon sending session information to DDS 126-B (e.g., after transaction 220 has been performed), and/or 2) upon receiving an ACK from DDS 126-B. According to one embodiment, the timing of when DDS 126-A and DDS 126-B send the ACKs is configurable, for example, through a command line interface (CLI).

At operation 245, Sd 125-A negotiates with a client device (e.g., client device 101) and creates a second session (e.g., session 152). At operation 250, Sd 125-A determines that the second session is not stateful (e.g., because the second session is not carried over an MC-LAG). In response to determining the second session is not stateful, Sd 125-A uses the second session to carry traffic, but does not store the session information associated with the second session in DDS 126-A. In this way, Sd 125-A prevents DDS 126-A from syncing the session information associated with the second session to DDS 126-B. For example, Sd 125-A determines that session 152 is not stateful because it is not carried over a MC-LAG. In response to such a determination, Sd 125-A uses session 152 to carry traffic, but does not store the session information associated with session 152 in DDS 126-A.

At transaction 255, a switchover event occurs. For example, network devices 107-A and 107-B switch roles (e.g., network device 107-A transitions to serving as the standby ICR device, and network device 107-B transitions to serving as the active ICR device). At operation 260, in response to the switchover event, Sd 125-B actives the first standby session and uses the activated first session to carry traffic, without having to negotiate with the client device. For example, Sd 125-B activates the standby session corresponding to session 151 (created by Sd 125-A) and uses the activated session to carry traffic, without having to negotiate with client device 101.

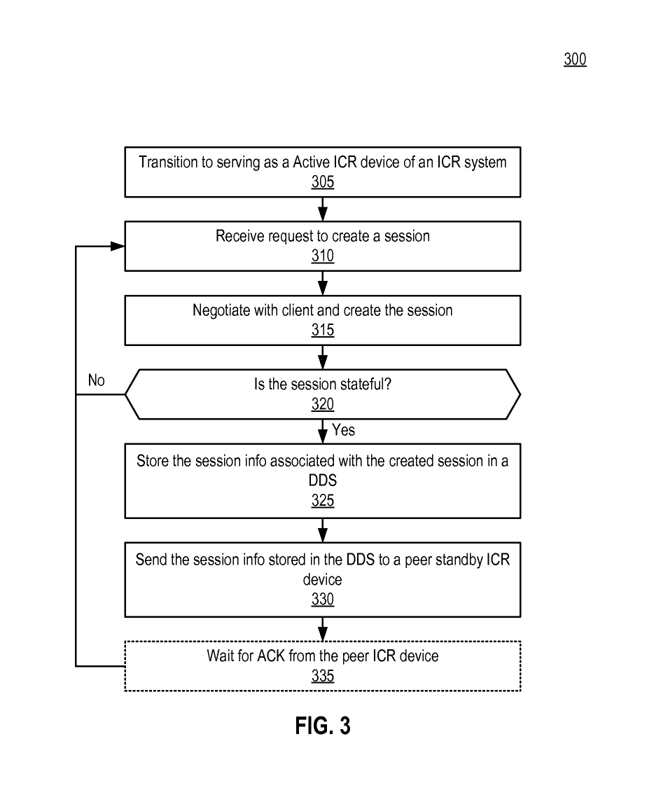

FIG. 3 is a flow diagram illustrating a method for performing fast switchover at an ICR system using MC-LAG according to one embodiment. For example, method 300 can be performed by network device 107-A. Method 300 can be implemented in software, firmware, hardware, or any combination thereof. The operations in this and other flow diagrams will be described with reference to the exemplary embodiments of the other figures. However, it should be understood that the operations of the flow diagrams can be performed by embodiments of the invention other than those discussed with reference to the other figures, and the embodiments of the invention discussed with reference to these other figures can perform operations different than those discussed with reference to the flow diagrams.

Referring now to FIG. 3, at block 305, a network device transitions to serving as an active ICR device of an ICR system. For example, network device 107-A transitions to serving as the active ICR device of ICR system 111. At block 310, the network device receives a request to create a session. For example, network device 107-A receives a request (e.g., from an administrator via a CLI) to create a session.

At block 315, the network device negotiates with a client device and creates the requested session. For example, Sd 125-A of network device 107-A negotiates with client device 101 to create session 151 or 152. At block 320, the network device determines whether the created session is stateful (e.g., by determining whether the created session is carried over an MC-LAG). In response to determining the created session is not stateful, the network device transitions back to block 310 and waits for the next request to create another session. For example, in response to determining session 152 is not stateful, network device 107-A transitions back to block 310. Alternatively, in response to determining the created session is stateful, the network device proceeds to block 325. For example, in response to determining session 151 is stateful, network device 107-A transitions to block 325.

At block 325, the network device stores the session information associated with the created session in a DDS. For example, network device 107-A stores session info 153-A in DDS 126-A. At block 330, the network device sends the session information stored in the DDS to a peer standby ICR device. For example, DDS 126-A sends session info 153-A to DDS 126-B via ICR channel 130, causing network device 107-B to create a standby session corresponding to session 151. At optional block 335, the network device waits for an ACK from the peer standby ICR device. As part of optional block 335, in response to receiving the ACK from the peer standby ICR device, the DDS of the network device sends an ACK to the session daemon which created the session. For example, in response to receiving an ACK from DDS 126-B, DDS 126-A sends an ACK to Sd 125-A which created session 151.

In an embodiment where optional block 335 is not implemented, the DDS of the network device sends an ACK to the Sd which created the session without waiting for an ACK from the peer standby ICR device, and returns to block 310. For example, after sending session info 153-A to DDS 126-B, DDS 126-A sends an ACK to Sd 125-A, without waiting for an ACK from DDS 126-B.

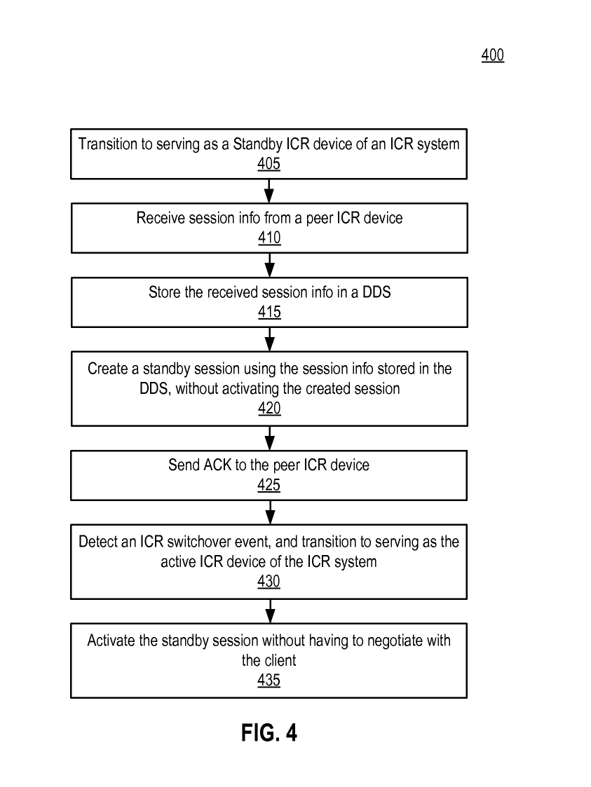

FIG. 4 is a flow diagram illustrating a method for performing fast switchover at an ICR system using MC-LAG according to one embodiment. For example, method 400 can be performed by network device 107-B. Method 400 can be implemented in software, firmware, hardware, or any combination thereof. Referring now to FIG. 4, at block 405 a network device transitions to serving as a standby ICR device of an ICR system. For example, network device 107-B transitions to serving as the standby ICR device of ICR system 111.

At block 410, the network device receives session information from a peer ICR device. For example, DDS 126-B of network device 107-B receives from DDS 126-A of network device 107-A session info 153-A which includes session information associated with session 151 created by Sd 125-A of network device 107-A. At block 415, the network device stores the received session information in a DDS. For example, DDS 126-B stores received session info 153-A as session info 153-B.

At block 420, the network device creates a standby session using the session information stored in the DDS, without activating the created session. For example, Sd 125-B creates a standby session using session info 153-B, without activating the created standby session, wherein the created standby session corresponds to session 151 created by Sd 125-A.

At block 425, the network device sends an ACK to the peer ICR device. For example, DDS 126-B sends an ACK to DDS 126-A. At block 430, the network device detects an ICR switchover event and transitions to serving as the active ICR device of the ICR system. For example, in response to receiving a notification from network device 107-A indicating it has transitioned or is in the process of transitioning to serving as the standby ICR device or in response to not receiving keep alive messages from network device 107-A, network device 107-B transitions to serving as the active ICR device. At block 435, the network device activates the standby session and uses the activated session to carry traffic, without having to negotiate with a client device. For example, Sd 125-B activates the standby session corresponding to session 151 and uses the activated session to carry traffic, without having to negotiate with client device 101.

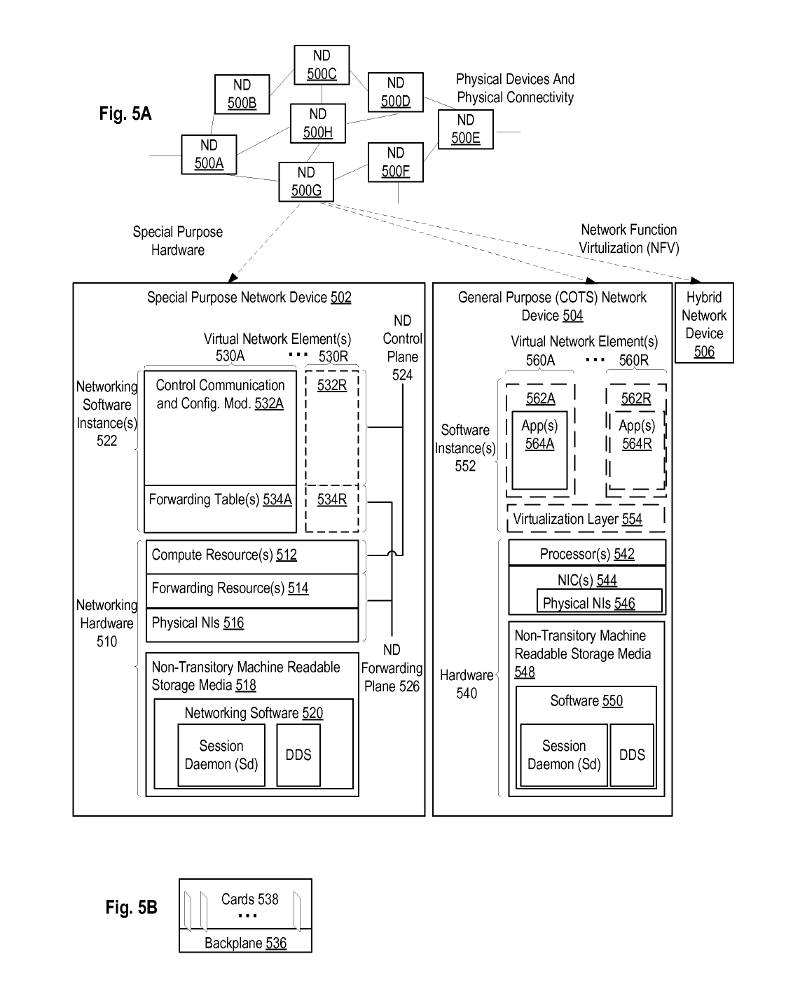

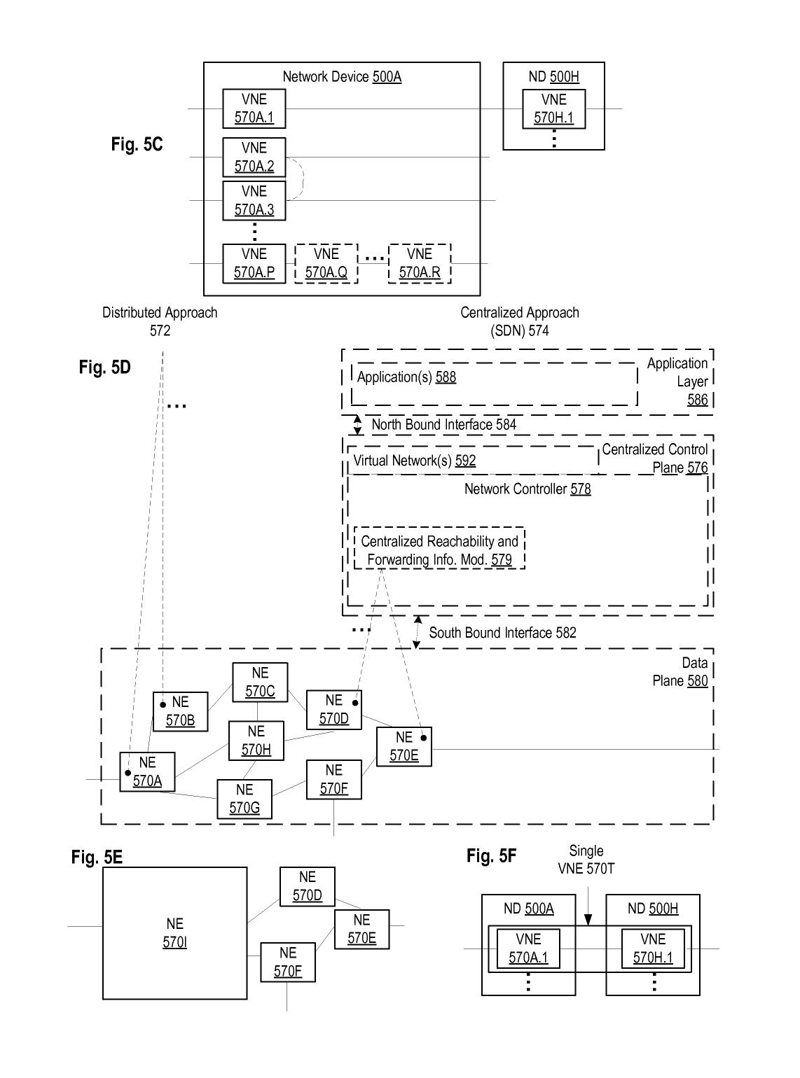

FIG. 5A illustrates connectivity between network devices (NDs) within an exemplary network, as well as three exemplary implementations of the NDs, according to some embodiments of the invention. FIG. 5A shows NDs 500A-H, and their connectivity by way of lines between A-B, B-C, C-D, D-E, E-F, F-G, and A-G, as well as between H and each of A, C, D, and G. These NDs are physical devices, and the connectivity between these NDs can be wireless or wired (often referred to as a link). An additional line extending from NDs 500A, E, and F illustrates that these NDs act as ingress and egress points for the network (and thus, these NDs are sometimes referred to as edge NDs; while the other NDs may be called core NDs).

Two of the exemplary ND implementations in FIG. 5A are: 1) a special-purpose network device 502 that uses custom application-specific integrated-circuits (ASICs) and a proprietary operating system (OS); and 2) a general purpose network device 504 that uses common off-the-shelf (COTS) processors and a standard OS.

The special-purpose network device 502 includes networking hardware 510 comprising compute resource(s) 512 (which typically include a set of one or more processors), forwarding resource(s) 514 (which typically include one or more ASICs and/or network processors), and physical network interfaces (NIs) 516 (sometimes called physical ports), as well as non-transitory machine readable storage media 518 having stored therein networking software 520. A physical NI is hardware in a ND through which a network connection (e.g., wirelessly through a wireless network interface controller (WNIC) or through plugging in a cable to a physical port connected to a network interface controller (NIC)) is made, such as those shown by the connectivity between NDs 500A-H. During operation, the networking software 520 may be executed by the networking hardware 510 to instantiate a set of one or more networking software instance(s) 522. Each of the networking software instance(s) 522, and that part of the networking hardware 510 that executes that network software instance (be it hardware dedicated to that networking software instance and/or time slices of hardware temporally shared by that networking software instance with others of the networking software instance(s) 522), form a separate virtual network element 530A-R. Each of the virtual network element(s) (VNEs) 530A-R includes a control communication and configuration module 532A-R (sometimes referred to as a local control module or control communication module) and forwarding table(s) 534A-R, such that a given virtual network element (e.g., 530A) includes the control communication and configuration module (e.g., 532A), a set of one or more forwarding table(s) (e.g., 534A), and that portion of the networking hardware 510 that executes the virtual network element (e.g., 530A).

Software 520 can include code which when executed by networking hardware 510, causes networking hardware 510 to perform operations of one or more embodiments of the present invention as part networking software instances 522.

The special-purpose network device 502 is often physically and/or logically considered to include: 1) a ND control plane 524 (sometimes referred to as a control plane) comprising the compute resource(s) 512 that execute the control communication and configuration module(s) 532A-R; and 2) a ND forwarding plane 526 (sometimes referred to as a forwarding plane, a data plane, or a media plane) comprising the forwarding resource(s) 514 that utilize the forwarding table(s) 534A-R and the physical NIs 516. By way of example, where the ND is a router (or is implementing routing functionality), the ND control plane 524 (the compute resource(s) 512 executing the control communication and configuration module(s) 532A-R) is typically responsible for participating in controlling how data (e.g., packets) is to be routed (e.g., the next hop for the data and the outgoing physical NI for that data) and storing that routing information in the forwarding table(s) 534A-R, and the ND forwarding plane 526 is responsible for receiving that data on the physical NIs 516 and forwarding that data out the appropriate ones of the physical NIs 516 based on the forwarding table(s) 534A-R.

FIG. 5B illustrates an exemplary way to implement the special-purpose network device 502 according to some embodiments of the invention. FIG. 5B shows a special-purpose network device including cards 538 (typically hot pluggable). While in some embodiments the cards 538 are of two types (one or more that operate as the ND forwarding plane 526 (sometimes called line cards), and one or more that operate to implement the ND control plane 524 (sometimes called control cards)), alternative embodiments may combine functionality onto a single card and/or include additional card types (e.g., one additional type of card is called a service card, resource card, or multi-application card). A service card can provide specialized processing (e.g., Layer 4 to Layer 7 services (e.g., firewall, Internet Protocol Security (IPsec), Secure Sockets Layer (SSL)/Transport Layer Security (TLS), Intrusion Detection System (IDS), peer-to-peer (P2P), Voice over IP (VoIP) Session Border Controller, Mobile Wireless Gateways (Gateway General Packet Radio Service (GPRS) Support Node (GGSN), Evolved Packet Core (EPC) Gateway)). By way of example, a service card may be used to terminate IPsec tunnels and execute the attendant authentication and encryption algorithms. These cards are coupled together through one or more interconnect mechanisms illustrated as backplane 536 (e.g., a first full mesh coupling the line cards and a second full mesh coupling all of the cards).

Returning to FIG. 5A, the general purpose network device 504 includes hardware 540 comprising a set of one or more processor(s) 542 (which are often COTS processors) and network interface controller(s) 544 (NICs; also known as network interface cards) (which include physical NIs 546), as well as non-transitory machine readable storage media 548 having stored therein software 550. During operation, the processor(s) 542 execute the software 550 to instantiate one or more sets of one or more applications 564A-R. While one embodiment does not implement virtualization, alternative embodiments may use different forms of virtualization—represented by a virtualization layer 554 and software containers 562A-R. For example, one such alternative embodiment implements operating system-level virtualization, in which case the virtualization layer 554 represents the kernel of an operating system (or a shim executing on a base operating system) that allows for the creation of multiple software containers 562A-R that may each be used to execute one of the sets of applications 564A-R. In this embodiment, the multiple software containers 562A-R (also called virtualization engines, virtual private servers, or jails) are each a user space instance (typically a virtual memory space); these user space instances are separate from each other and separate from the kernel space in which the operating system is run; the set of applications running in a given user space, unless explicitly allowed, cannot access the memory of the other processes. Another such alternative embodiment implements full virtualization, in which case: 1) the virtualization layer 554 represents a hypervisor (sometimes referred to as a virtual machine monitor (VMM)) or a hypervisor executing on top of a host operating system; and 2) the software containers 562A-R each represent a tightly isolated form of software container called a virtual machine that is run by the hypervisor and may include a guest operating system. A virtual machine is a software implementation of a physical machine that runs programs as if they were executing on a physical, non-virtualized machine; and applications generally do not know they are running on a virtual machine as opposed to running on a “bare metal” host electronic device, though some systems provide para-virtualization which allows an operating system or application to be aware of the presence of virtualization for optimization purposes.

The instantiation of the one or more sets of one or more applications 564A-R, as well as the virtualization layer 554 and software containers 562A-R if implemented, are collectively referred to as software instance(s) 552. Each set of applications 564A-R, corresponding software container 562A-R if implemented, and that part of the hardware 540 that executes them (be it hardware dedicated to that execution and/or time slices of hardware temporally shared by software containers 562A-R), forms a separate virtual network element(s) 560A-R.

The virtual network element(s) 560A-R perform similar functionality to the virtual network element(s) 530A-R—e.g., similar to the control communication and configuration module(s) 532A and forwarding table(s) 534A (this virtualization of the hardware 540 is sometimes referred to as network function virtualization (NFV)). Thus, NFV may be used to consolidate many network equipment types onto industry standard high volume server hardware, physical switches, and physical storage, which could be located in Data centers, NDs, and customer premise equipment (CPE). However, different embodiments of the invention may implement one or more of the software container(s) 562A-R differently. For example, while embodiments of the invention are illustrated with each software container 562A-R corresponding to one VNE 560A-R, alternative embodiments may implement this correspondence at a finer level granularity (e.g., line card virtual machines virtualize line cards, control card virtual machine virtualize control cards, etc.); it should be understood that the techniques described herein with reference to a correspondence of software containers 562A-R to VNEs also apply to embodiments where such a finer level of granularity is used.

In certain embodiments, the virtualization layer 554 includes a virtual switch that provides similar forwarding services as a physical Ethernet switch. Specifically, this virtual switch forwards traffic between software containers 562A-R and the NIC(s) 544, as well as optionally between the software containers 562A-R; in addition, this virtual switch may enforce network isolation between the VNEs 560A-R that by policy are not permitted to communicate with each other (e.g., by honoring virtual local area networks (VLANs)).

Software 550 can include code which when executed by processor(s) 542, cause processor(s) 542 to perform operations of one or more embodiments of the present invention as part software containers 562A-R.

The third exemplary ND implementation in FIG. 5A is a hybrid network device 506, which includes both custom ASICs/proprietary OS and COTS processors/standard OS in a single ND or a single card within an ND. In certain embodiments of such a hybrid network device, a platform VM (i.e., a VM that that implements the functionality of the special-purpose network device 502) could provide for para-virtualization to the networking hardware present in the hybrid network device 506.

Regardless of the above exemplary implementations of an ND, when a single one of multiple VNEs implemented by an ND is being considered (e.g., only one of the VNEs is part of a given virtual network) or where only a single VNE is currently being implemented by an ND, the shortened term network element (NE) is sometimes used to refer to that VNE. Also in all of the above exemplary implementations, each of the VNEs (e.g., VNE(s) 530A-R, VNEs 560A-R, and those in the hybrid network device 506) receives data on the physical NIs (e.g., 516, 546) and forwards that data out the appropriate ones of the physical NIs (e.g., 516, 546). For example, a VNE implementing IP router functionality forwards IP packets on the basis of some of the IP header information in the IP packet; where IP header information includes source IP address, destination IP address, source port, destination port (where “source port” and “destination port” refer herein to protocol ports, as opposed to physical ports of a ND), transport protocol (e.g., user datagram protocol (UDP), Transmission Control Protocol (TCP), and differentiated services (DSCP) values.

FIG. 5C illustrates various exemplary ways in which VNEs may be coupled according to some embodiments of the invention. FIG. 5C shows VNEs 570A.1-570A.P (and optionally VNEs 570A.Q-570A.R) implemented in ND 500A and VNE 570H.1 in ND 500H. In FIG. 5C, VNEs 570A.1-P are separate from each other in the sense that they can receive packets from outside ND 500A and forward packets outside of ND 500A; VNE 570A.1 is coupled with VNE 570H.1, and thus they communicate packets between their respective NDs; VNE 570A.2-570A.3 may optionally forward packets between themselves without forwarding them outside of the ND 500A; and VNE 570A.P may optionally be the first in a chain of VNEs that includes VNE 570A.Q followed by VNE 570A.R (this is sometimes referred to as dynamic service chaining, where each of the VNEs in the series of VNEs provides a different service—e.g., one or more layer 4-7 network services). While FIG. 5C illustrates various exemplary relationships between the VNEs, alternative embodiments may support other relationships (e.g., more/fewer VNEs, more/fewer dynamic service chains, multiple different dynamic service chains with some common VNEs and some different VNEs).

The NDs of FIG. 5A, for example, may form part of the Internet or a private network; and other electronic devices (not shown; such as end user devices including workstations, laptops, netbooks, tablets, palm tops, mobile phones, smartphones, phablets, multimedia phones, Voice Over Internet Protocol (VOIP) phones, terminals, portable media players, GPS units, wearable devices, gaming systems, set-top boxes, Internet enabled household appliances) may be coupled to the network (directly or through other networks such as access networks) to communicate over the network (e.g., the Internet or virtual private networks (VPNs) overlaid on (e.g., tunneled through) the Internet) with each other (directly or through servers) and/or access content and/or services. Such content and/or services are typically provided by one or more servers (not shown) belonging to a service/content provider or one or more end user devices (not shown) participating in a peer-to-peer (P2P) service, and may include, for example, public webpages (e.g., free content, store fronts, search services), private webpages (e.g., username/password accessed webpages providing email services), and/or corporate networks over VPNs. For instance, end user devices may be coupled (e.g., through customer premise equipment coupled to an access network (wired or wirelessly)) to edge NDs, which are coupled (e.g., through one or more core NDs) to other edge NDs, which are coupled to electronic devices acting as servers. However, through compute and storage virtualization, one or more of the electronic devices operating as the NDs in FIG. 5A may also host one or more such servers (e.g., in the case of the general purpose network device 504, one or more of the software containers 562A-R may operate as servers; the same would be true for the hybrid network device 506; in the case of the special-purpose network device 502, one or more such servers could also be run on a virtualization layer executed by the compute resource(s) 512); in which case the servers are said to be co-located with the VNEs of that ND.

A virtual network is a logical abstraction of a physical network (such as that in FIG. 5A) that provides network services (e.g., L2 and/or L3 services). A virtual network can be implemented as an overlay network (sometimes referred to as a network virtualization overlay) that provides network services (e.g., layer 2 (L2, data link layer) and/or layer 3 (L3, network layer) services) over an underlay network (e.g., an L3 network, such as an Internet Protocol (IP) network that uses tunnels (e.g., generic routing encapsulation (GRE), layer 2 tunneling protocol (L2TP), IPSec) to create the overlay network).

A network virtualization edge (NVE) sits at the edge of the underlay network and participates in implementing the network virtualization; the network-facing side of the NVE uses the underlay network to tunnel frames to and from other NVEs; the outward-facing side of the NVE sends and receives data to and from systems outside the network. A virtual network instance (VNI) is a specific instance of a virtual network on a NVE (e.g., a NE/VNE on an ND, a part of a NE/VNE on a ND where that NE/VNE is divided into multiple VNEs through emulation); one or more VNIs can be instantiated on an NVE (e.g., as different VNEs on an ND). A virtual access point (VAP) is a logical connection point on the NVE for connecting external systems to a virtual network; a VAP can be physical or virtual ports identified through logical interface identifiers (e.g., a VLAN ID).

Examples of network services include: 1) an Ethernet LAN emulation service (an Ethernet-based multipoint service similar to an Internet Engineering Task Force (IETF) Multiprotocol Label Switching (MPLS) or Ethernet VPN (EVPN) service) in which external systems are interconnected across the network by a LAN environment over the underlay network (e.g., an NVE provides separate L2 VNIs (virtual switching instances) for different such virtual networks, and L3 (e.g., IP/MPLS) tunneling encapsulation across the underlay network); and 2) a virtualized IP forwarding service (similar to IETF IP VPN (e.g., Border Gateway Protocol (BGP)/MPLS IPVPN) from a service definition perspective) in which external systems are interconnected across the network by an L3 environment over the underlay network (e.g., an NVE provides separate L3 VNIs (forwarding and routing instances) for different such virtual networks, and L3 (e.g., IP/MPLS) tunneling encapsulation across the underlay network)). Network services may also include quality of service capabilities (e.g., traffic classification marking, traffic conditioning and scheduling), security capabilities (e.g., filters to protect customer premises from network—originated attacks, to avoid malformed route announcements), and management capabilities (e.g., full detection and processing).

FIG. 5D illustrates a network with a single network element on each of the NDs of FIG. 5A, and within this straight forward approach contrasts a traditional distributed approach (commonly used by traditional routers) with a centralized approach for maintaining reachability and forwarding information (also called network control), according to some embodiments of the invention. Specifically, FIG. 5D illustrates network elements (NEs) 570A-H with the same connectivity as the NDs 500A-H of FIG. 5A.

FIG. 5D illustrates that the distributed approach 572 distributes responsibility for generating the reachability and forwarding information across the NEs 570A-H; in other words, the process of neighbor discovery and topology discovery is distributed.

For example, where the special-purpose network device 502 is used, the control communication and configuration module(s) 532A-R of the ND control plane 524 typically include a reachability and forwarding information module to implement one or more routing protocols (e.g., an exterior gateway protocol such as Border Gateway Protocol (BGP), Interior Gateway Protocol(s) (IGP) (e.g., Open Shortest Path First (OSPF), Intermediate System to Intermediate System (IS-IS), Routing Information Protocol (RIP)), Label Distribution Protocol (LDP), Resource Reservation Protocol (RSVP), as well as RSVP-Traffic Engineering (TE): Extensions to RSVP for LSP Tunnels, Generalized Multi-Protocol Label Switching (GMPLS) Signaling RSVP-TE that communicate with other NEs to exchange routes, and then selects those routes based on one or more routing metrics. Thus, the NEs 570A-H (e.g., the compute resource(s) 512 executing the control communication and configuration module(s) 532A-R) perform their responsibility for participating in controlling how data (e.g., packets) is to be routed (e.g., the next hop for the data and the outgoing physical NI for that data) by distributively determining the reachability within the network and calculating their respective forwarding information. Routes and adjacencies are stored in one or more routing structures (e.g., Routing Information Base (RIB), Label Information Base (LIB), one or more adjacency structures) on the ND control plane 524. The ND control plane 524 programs the ND forwarding plane 526 with information (e.g., adjacency and route information) based on the routing structure(s). For example, the ND control plane 524 programs the adjacency and route information into one or more forwarding table(s) 534A-R (e.g., Forwarding Information Base (FIB), Label Forwarding Information Base (LFIB), and one or more adjacency structures) on the ND forwarding plane 526. For layer 2 forwarding, the ND can store one or more bridging tables that are used to forward data based on the layer 2 information in that data. While the above example uses the special-purpose network device 502, the same distributed approach 572 can be implemented on the general purpose network device 504 and the hybrid network device 506.

FIG. 5D illustrates that a centralized approach 574 (also known as software defined networking (SDN)) that decouples the system that makes decisions about where traffic is sent from the underlying systems that forwards traffic to the selected destination. The illustrated centralized approach 574 has the responsibility for the generation of reachability and forwarding information in a centralized control plane 576 (sometimes referred to as a SDN control module, controller, network controller, OpenFlow controller, SDN controller, control plane node, network virtualization authority, or management control entity), and thus the process of neighbor discovery and topology discovery is centralized. The centralized control plane 576 has a south bound interface 582 with a data plane 580 (sometime referred to the infrastructure layer, network forwarding plane, or forwarding plane (which should not be confused with a ND forwarding plane)) that includes the NEs 570A-H (sometimes referred to as switches, forwarding elements, data plane elements, or nodes). The centralized control plane 576 includes a network controller 578, which includes a centralized reachability and forwarding information module 579 that determines the reachability within the network and distributes the forwarding information to the NEs 570A-H of the data plane 580 over the south bound interface 582 (which may use the OpenFlow protocol). Thus, the network intelligence is centralized in the centralized control plane 576 executing on electronic devices that are typically separate from the NDs.

For example, where the special-purpose network device 502 is used in the data plane 580, each of the control communication and configuration module(s) 532A-R of the ND control plane 524 typically include a control agent that provides the VNE side of the south bound interface 582. In this case, the ND control plane 524 (the compute resource(s) 512 executing the control communication and configuration module(s) 532A-R) performs its responsibility for participating in controlling how data (e.g., packets) is to be routed (e.g., the next hop for the data and the outgoing physical NI for that data) through the control agent communicating with the centralized control plane 576 to receive the forwarding information (and in some cases, the reachability information) from the centralized reachability and forwarding information module 579 (it should be understood that in some embodiments of the invention, the control communication and configuration module(s) 532A-R, in addition to communicating with the centralized control plane 576, may also play some role in determining reachability and/or calculating forwarding information—albeit less so than in the case of a distributed approach; such embodiments are generally considered to fall under the centralized approach 574, but may also be considered a hybrid approach).

While the above example uses the special-purpose network device 502, the same centralized approach 574 can be implemented with the general purpose network device 504 (e.g., each of the VNE 560A-R performs its responsibility for controlling how data (e.g., packets) is to be routed (e.g., the next hop for the data and the outgoing physical NI for that data) by communicating with the centralized control plane 576 to receive the forwarding information (and in some cases, the reachability information) from the centralized reachability and forwarding information module 579; it should be understood that in some embodiments of the invention, the VNEs 560A-R, in addition to communicating with the centralized control plane 576, may also play some role in determining reachability and/or calculating forwarding information—albeit less so than in the case of a distributed approach) and the hybrid network device 506. In fact, the use of SDN techniques can enhance the NFV techniques typically used in the general purpose network device 504 or hybrid network device 506 implementations as NFV is able to support SDN by providing an infrastructure upon which the SDN software can be run, and NFV and SDN both aim to make use of commodity server hardware and physical switches.

FIG. 5D also shows that the centralized control plane 576 has a north bound interface 584 to an application layer 586, in which resides application(s) 588. The centralized control plane 576 has the ability to form virtual networks 592 (sometimes referred to as a logical forwarding plane, network services, or overlay networks (with the NEs 570A-H of the data plane 580 being the underlay network)) for the application(s) 588. Thus, the centralized control plane 576 maintains a global view of all NDs and configured NEs/VNEs, and it maps the virtual networks to the underlying NDs efficiently (including maintaining these mappings as the physical network changes either through hardware (ND, link, or ND component) failure, addition, or removal).

While FIG. 5D shows the distributed approach 572 separate from the centralized approach 574, the effort of network control may be distributed differently or the two combined in certain embodiments of the invention. For example: 1) embodiments may generally use the centralized approach (SDN) 574, but have certain functions delegated to the NEs (e.g., the distributed approach may be used to implement one or more of fault monitoring, performance monitoring, protection switching, and primitives for neighbor and/or topology discovery); or 2) embodiments of the invention may perform neighbor discovery and topology discovery via both the centralized control plane and the distributed protocols, and the results compared to raise exceptions where they do not agree. Such embodiments are generally considered to fall under the centralized approach 574, but may also be considered a hybrid approach.

While FIG. 5D illustrates the simple case where each of the NDs 500A-H implements a single NE 570A-H, it should be understood that the network control approaches described with reference to FIG. 5D also work for networks where one or more of the NDs 500A-H implement multiple VNEs (e.g., VNEs 530A-R, VNEs 560A-R, those in the hybrid network device 506). Alternatively or in addition, the network controller 578 may also emulate the implementation of multiple VNEs in a single ND. Specifically, instead of (or in addition to) implementing multiple VNEs in a single ND, the network controller 578 may present the implementation of a VNE/NE in a single ND as multiple VNEs in the virtual networks 592 (all in the same one of the virtual network(s) 592, each in different ones of the virtual network(s) 592, or some combination). For example, the network controller 578 may cause an ND to implement a single VNE (a NE) in the underlay network, and then logically divide up the resources of that NE within the centralized control plane 576 to present different VNEs in the virtual network(s) 592 (where these different VNEs in the overlay networks are sharing the resources of the single VNE/NE implementation on the ND in the underlay network).

On the other hand, FIGS. 5E and 5F respectively illustrate exemplary abstractions of NEs and VNEs that the network controller 578 may present as part of different ones of the virtual networks 592. FIG. 5E illustrates the simple case of where each of the NDs 500A-H implements a single NE 570A-H (see FIG. 5D), but the centralized control plane 576 has abstracted multiple of the NEs in different NDs (the NEs 570A-C and G-H) into (to represent) a single NE 5701 in one of the virtual network(s) 592 of FIG. 5D, according to some embodiments of the invention. FIG. 5E shows that in this virtual network, the NE 5701 is coupled to NE 570D and 570F, which are both still coupled to NE 570E.

FIG. 5F illustrates a case where multiple VNEs (VNE 570A.1 and VNE 570H.1) are implemented on different NDs (ND 500A and ND 500H) and are coupled to each other, and where the centralized control plane 576 has abstracted these multiple VNEs such that they appear as a single VNE 570T within one of the virtual networks 592 of FIG. 5D, according to some embodiments of the invention. Thus, the abstraction of a NE or VNE can span multiple NDs.

While some embodiments of the invention implement the centralized control plane 576 as a single entity (e.g., a single instance of software running on a single electronic device), alternative embodiments may spread the functionality across multiple entities for redundancy and/or scalability purposes (e.g., multiple instances of software running on different electronic devices).

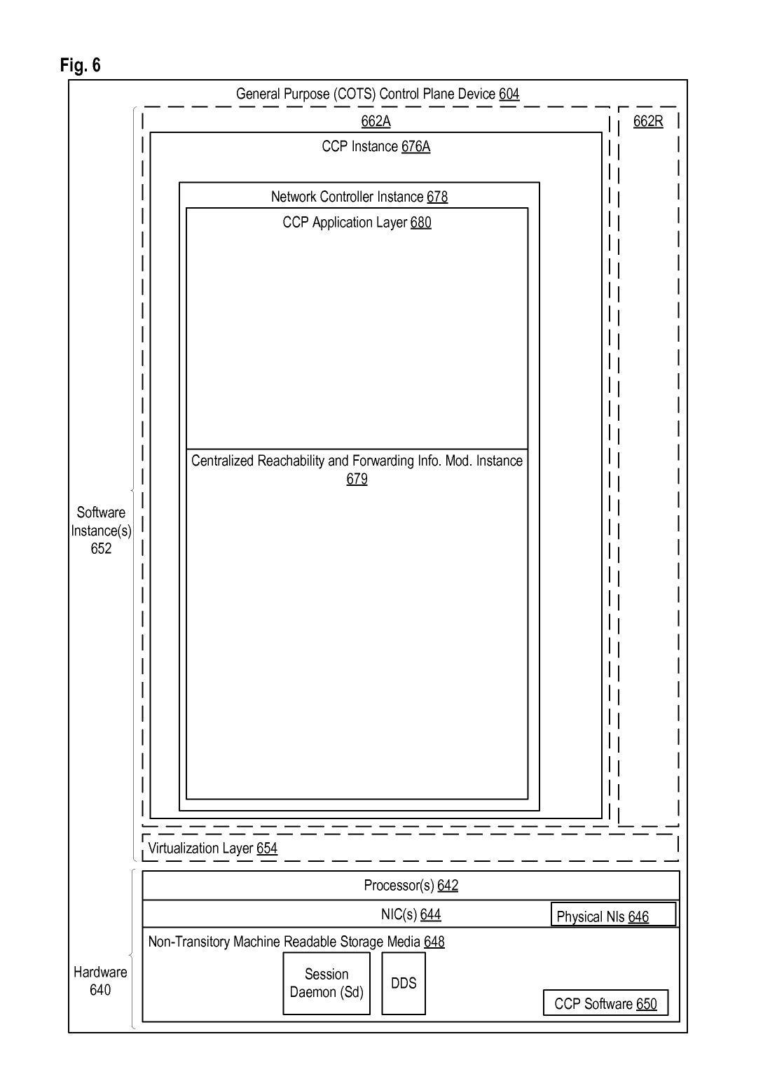

Similar to the network device implementations, the electronic device(s) running the centralized control plane 576, and thus the network controller 578 including the centralized reachability and forwarding information module 579, may be implemented a variety of ways (e.g., a special purpose device, a general-purpose (e.g., COTS) device, or hybrid device). These electronic device(s) would similarly include compute resource(s), a set or one or more physical NICs, and a non-transitory machine-readable storage medium having stored thereon the centralized control plane software. For instance, FIG. 6 illustrates, a general purpose control plane device 604 including hardware 640 comprising a set of one or more processor(s) 642 (which are often COTS processors) and network interface controller(s) 644 (NICs; also known as network interface cards) (which include physical NIs 646), as well as non-transitory machine readable storage media 648 having stored therein centralized control plane (CCP) software 650.

In embodiments that use compute virtualization, the processor(s) 642 typically execute software to instantiate a virtualization layer 654 and software container(s) 662A-R (e.g., with operating system-level virtualization, the virtualization layer 654 represents the kernel of an operating system (or a shim executing on a base operating system) that allows for the creation of multiple software containers 662A-R (representing separate user space instances and also called virtualization engines, virtual private servers, or jails) that may each be used to execute a set of one or more applications; with full virtualization, the virtualization layer 654 represents a hypervisor (sometimes referred to as a virtual machine monitor (VMM)) or a hypervisor executing on top of a host operating system, and the software containers 662A-R each represent a tightly isolated form of software container called a virtual machine that is run by the hypervisor and may include a guest operating system; with para-virtualization, an operating system or application running with a virtual machine may be aware of the presence of virtualization for optimization purposes). Again, in embodiments where compute virtualization is used, during operation an instance of the CCP software 650 (illustrated as CCP instance 676A) is executed within the software container 662A on the virtualization layer 654. In embodiments where compute virtualization is not used, the CCP instance 676A on top of a host operating system is executed on the “bare metal” general purpose control plane device 604. The instantiation of the CCP instance 676A, as well as the virtualization layer 654 and software containers 662A-R if implemented, are collectively referred to as software instance(s) 652.

In some embodiments, the CCP instance 676A includes a network controller instance 678. The network controller instance 678 includes a centralized reachability and forwarding information module instance 679 (which is a middleware layer providing the context of the network controller 578 to the operating system and communicating with the various NEs), and an CCP application layer 680 (sometimes referred to as an application layer) over the middleware layer (providing the intelligence required for various network operations such as protocols, network situational awareness, and user—interfaces). At a more abstract level, this CCP application layer 680 within the centralized control plane 576 works with virtual network view(s) (logical view(s) of the network) and the middleware layer provides the conversion from the virtual networks to the physical view.

The centralized control plane 576 transmits relevant messages to the data plane 580 based on CCP application layer 680 calculations and middleware layer mapping for each flow. A flow may be defined as a set of packets whose headers match a given pattern of bits; in this sense, traditional IP forwarding is also flow—based forwarding where the flows are defined by the destination IP address for example; however, in other implementations, the given pattern of bits used for a flow definition may include more fields (e.g., 10 or more) in the packet headers. Different NDs/NEs/VNEs of the data plane 580 may receive different messages, and thus different forwarding information. The data plane 580 processes these messages and programs the appropriate flow information and corresponding actions in the forwarding tables (sometime referred to as flow tables) of the appropriate NE/VNEs, and then the NEs/VNEs map incoming packets to flows represented in the forwarding tables and forward packets based on the matches in the forwarding tables.

Standards such as OpenFlow define the protocols used for the messages, as well as a model for processing the packets. The model for processing packets includes header parsing, packet classification, and making forwarding decisions. Header parsing describes how to interpret a packet based upon a well-known set of protocols. Some protocol fields are used to build a match structure (or key) that will be used in packet classification (e.g., a first key field could be a source media access control (MAC) address, and a second key field could be a destination MAC address).

Packet classification involves executing a lookup in memory to classify the packet by determining which entry (also referred to as a forwarding table entry or flow entry) in the forwarding tables best matches the packet based upon the match structure, or key, of the forwarding table entries. It is possible that many flows represented in the forwarding table entries can correspond/match to a packet; in this case the system is typically configured to determine one forwarding table entry from the many according to a defined scheme (e.g., selecting a first forwarding table entry that is matched). Forwarding table entries include both a specific set of match criteria (a set of values or wildcards, or an indication of what portions of a packet should be compared to a particular value/values/wildcards, as defined by the matching capabilities—for specific fields in the packet header, or for some other packet content), and a set of one or more actions for the data plane to take on receiving a matching packet. For example, an action may be to push a header onto the packet, for the packet using a particular port, flood the packet, or simply drop the packet. Thus, a forwarding table entry for IPv4/IPv6 packets with a particular transmission control protocol (TCP) destination port could contain an action specifying that these packets should be dropped.

Making forwarding decisions and performing actions occurs, based upon the forwarding table entry identified during packet classification, by executing the set of actions identified in the matched forwarding table entry on the packet.

However, when an unknown packet (for example, a “missed packet” or a “match-miss” as used in OpenFlow parlance) arrives at the data plane 580, the packet (or a subset of the packet header and content) is typically forwarded to the centralized control plane 576. The centralized control plane 576 will then program forwarding table entries into the data plane 580 to accommodate packets belonging to the flow of the unknown packet. Once a specific forwarding table entry has been programmed into the data plane 580 by the centralized control plane 576, the next packet with matching credentials will match that forwarding table entry and take the set of actions associated with that matched entry.

A network interface (NI) may be physical or virtual; and in the context of IP, an interface address is an IP address assigned to a NI, be it a physical NI or virtual NI. A virtual NI may be associated with a physical NI, with another virtual interface, or stand on its own (e.g., a loopback interface, a point-to-point protocol interface). A NI (physical or virtual) may be numbered (a NI with an IP address) or unnumbered (a NI without an IP address). A loopback interface (and its loopback address) is a specific type of virtual NI (and IP address) of a NE/VNE (physical or virtual) often used for management purposes; where such an IP address is referred to as the nodal loopback address. The IP address(es) assigned to the NI(s) of a ND are referred to as IP addresses of that ND; at a more granular level, the IP address(es) assigned to NI(s) assigned to a NE/VNE implemented on a ND can be referred to as IP addresses of that NE/VNE.

A Layer 3 (L3) Link Aggregation (LAG) link is a link directly connecting two NDs with multiple IP-addressed link paths (each link path is assigned a different IP address), and a load distribution decision across these different link paths is performed at the ND forwarding plane; in which case, a load distribution decision is made between the link paths.

Some NDs include functionality for authentication, authorization, and accounting (AAA) protocols (e.g., RADIUS (Remote Authentication Dial-In User Service), Diameter, and/or TACACS+ (Terminal Access Controller Access Control System Plus). AAA can be provided through a client/server model, where the AAA client is implemented on a ND and the AAA server can be implemented either locally on the ND or on a remote electronic device coupled with the ND. Authentication is the process of identifying and verifying a subscriber. For instance, a subscriber might be identified by a combination of a username and a password or through a unique key. Authorization determines what a subscriber can do after being authenticated, such as gaining access to certain electronic device information resources (e.g., through the use of access control policies). Accounting is recording user activity. By way of a summary example, end user devices may be coupled (e.g., through an access network) through an edge ND (supporting AAA processing) coupled to core NDs coupled to electronic devices implementing servers of service/content providers. AAA processing is performed to identify for a subscriber the subscriber record stored in the AAA server for that subscriber. A subscriber record includes a set of attributes (e.g., subscriber name, password, authentication information, access control information, rate-limiting information, policing information) used during processing of that subscriber's traffic.

Certain NDs (e.g., certain edge NDs) internally represent end user devices (or sometimes customer premise equipment (CPE) such as a residential gateway (e.g., a router, modem)) using subscriber circuits. A subscriber circuit uniquely identifies within the ND a subscriber session and typically exists for the lifetime of the session. Thus, a ND typically allocates a subscriber circuit when the subscriber connects to that ND, and correspondingly de-allocates that subscriber circuit when that subscriber disconnects. Each subscriber session represents a distinguishable flow of packets communicated between the ND and an end user device (or sometimes CPE such as a residential gateway or modem) using a protocol, such as the point-to-point protocol over another protocol (PPPoX) (e.g., where X is Ethernet or Asynchronous Transfer Mode (ATM)), Ethernet, 802.1 Q Virtual LAN (VLAN), Internet Protocol, or ATM). A subscriber session can be initiated using a variety of mechanisms (e.g., manual provisioning a dynamic host configuration protocol (DHCP), DHCP/client-less internet protocol service (CLIPS) or Media Access Control (MAC) address tracking). For example, the point-to-point protocol (PPP) is commonly used for digital subscriber line (DSL) services and requires installation of a PPP client that enables the subscriber to enter a username and a password, which in turn may be used to select a subscriber record. When DHCP is used (e.g., for cable modem services), a username typically is not provided; but in such situations other information (e.g., information that includes the MAC address of the hardware in the end user device (or CPE)) is provided. The use of DHCP and CLIPS on the ND captures the MAC addresses and uses these addresses to distinguish subscribers and access their subscriber records.

Some portions of the preceding detailed descriptions have been presented in terms of algorithms and symbolic representations of transactions on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of transactions leading to a desired result. The transactions are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The algorithms and displays presented herein are not inherently related to any particular computer or other apparatus. Various general-purpose systems may be used with programs in accordance with the teachings herein, or it may prove convenient to construct more specialized apparatus to perform the required method transactions. The required structure for a variety of these systems will appear from the description above. In addition, embodiments of the present invention are not described with reference to any particular programming language. It will be appreciated that a variety of programming languages may be used to implement the teachings of embodiments of the invention as described herein.

In the foregoing specification, embodiments of the invention have been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

Throughout the description, embodiments of the present invention have been presented through flow diagrams. It will be appreciated that the order of transactions and transactions described in these flow diagrams are only intended for illustrative purposes and not intended as a limitation of the present invention. One having ordinary skill in the art would recognize that variations can be made to the flow diagrams without departing from the broader spirit and scope of the invention as set forth in the following claims.

What is claimed is:

1. A method in a first network device of an inter-chassis redundancy (ICR) system that is communicatively coupled to a second network device of the ICR system, wherein the first network device configured to serve as an active ICR device of the ICR system is communicatively coupled to a third network device via a first link and a third link, and wherein the second network device configured to serve as a standby ICR device of the ICR system is communicatively coupled to the third network device via a second link, wherein the first link and the second link belong to a first multi-chassis link aggregation group (MC-LAG), and wherein the third network device is communicatively coupled to a plurality of client devices, the method comprising:
negotiating with a first client device of the plurality of client devices to create a first session that is carried over the first link associated with the first MC-LAG;
determining whether the first session is stateful, wherein a session is stateful if it is carried over an MC-LAG; and
in response to determining the first session is stateful, sending session information associated with the first session to the second network device, causing the second network device to use the session information to create a standby session corresponding to the first session.

2. The method of claim 1, further comprising:
negotiating with a second client device of the plurality of client devices to create a second session that is carried over the third link; and
in response to determining the second session is not stateful, using the second session to carry traffic without sending session information associated with the second session to the second network device.

3. The method of claim 1, further comprising:
detecting a failure that prevents the first session to carry traffic over the first link of the first MC-LAG; and
in response to detecting the failure, performing an ICR switchover by:
transitioning to serving as the standby ICR device of the ICR system, and
sending a notification of the ICR switchover to the second network device, causing the second network device to transition to serving as the active ICR device of the ICR system, and further causing the second network device to activate the standby session and use the activated session to carry traffic without having to negotiate with the first client device.

4. The method of claim 1, wherein sending the session information associated with the first session to the second network device comprises:
storing the session information associated with the first session in a distributed database system (DDS), wherein the DDS is configured to provide an indication, wherein the indication comprises of at least one of an indication that the session information has been sent to a peer ICR device, an indication that the session information has been received by a DDS at the peer ICR device, and an indication that the session information has been sent by the DDS at the peer device to a session daemon at the peer ICR device.

5. A first network device of an inter-chassis redundancy (ICR) system that is communicatively coupled to a second network device of the ICR system, wherein the first network device configured to serve as an active ICR device of the ICR system is communicatively coupled to a third network device via a first link and a third link, and wherein the second network device configured to serve as a standby ICR device of the ICR system is communicatively coupled to the third network device via a second link, wherein the first link and the second link belong to a first multi-chassis link aggregation group (MC-LAG), and wherein the third network device is communicatively coupled to a plurality of client devices, the first network device comprising:
a set of one or more processors; and
a non-transitory machine-readable storage medium containing code, which when executed by the set of one or more processors, causes the first network device to:
negotiate with a first client device of the plurality of client devices to create a first session that is carried over the first link associated with the first MC-LAG,
determine whether the first session is stateful, wherein a session is stateful if it is carried over an MC-LAG, and
in response to determining the first session is stateful, send session information associated with the first session to the second network device, causing the second network device to use the session information to create a standby session corresponding to the first session.

6. The first network device of claim 5, wherein the non-transitory machine-readable storage medium further contains code, which when executed by the set of one or more processors, causes the first network device to:
negotiate with a second client device of the plurality of client devices to create a second session that is carried over the third link; and
in response to determining the second session is not stateful, use the second session to carry traffic without sending session information associated with the second session to the second network device.

7. The first network device of claim 5, wherein the non-transitory machine-readable storage medium further contains code, which when executed by the set of one or more processors, causes the first network device to:
detect a failure that prevents the first session to carry traffic over the first link of the first MC-LAG; and
in response to detecting the failure, perform an ICR switchover by:
transitioning to serving as the standby ICR device of the ICR system, and
sending a notification of the ICR switchover to the second network device, causing the second network device to transition to serving as the active ICR device of the ICR system, and further causing the second network device to activate the standby session and use the activated session to carry traffic without having to negotiate with the first client device.

8. The first network device of claim 5, wherein sending the session information associated with the first session to the second network device comprises:
storing the session information associated with the first session in a distributed database system (DDS), wherein the DDS is configured to provide an indication, wherein the indication comprises of at least one of an indication that the session information has been sent to a peer ICR device, an indication that the session information has been received by a DDS at the peer ICR device, and an indication that the session information has been sent by the DDS at the peer device to a session daemon at the peer ICR device.

9. A non-transitory machine-readable storage medium having computer code stored therein, which when executed by a set of one or more processors of a first network device of an inter-chassis redundancy (ICR) system that is communicatively coupled to a second network device of the ICR system, wherein the first network device configured to serve as an active ICR device of the ICR system is communicatively coupled to a third network device via a first link and a third link, and wherein the second network device configured to serve as a standby ICR device of the ICR system is communicatively coupled to the third network device via a second link, wherein the first link and the second link belong to a first multi-chassis link aggregation group (MC-LAG), and wherein the third network device is communicatively coupled to a plurality of client devices, causes the first network device to perform operations comprising:
negotiating with a first client device of the plurality of client devices to create a first session that is carried over the first link associated with the first MC-LAG;
determining whether the first session is stateful, wherein a session is stateful if it is carried over an MC-LAG; and
in response to determining the first session is stateful, sending session information associated with the first session to the second network device, causing the second network device to use the session information to create a standby session corresponding to the first session.

10. The non-transitory machine-readable storage medium of claim 9, further comprising:
negotiating with a second client device of the plurality of client devices to create a second session that is carried over the third link; and
in response to determining the second session is not stateful, using the second session to carry traffic without sending session information associated with the second session to the second network device.

11. The non-transitory machine-readable storage medium of claim 9, further comprising:
detecting a failure that prevents the first session to carry traffic over the first link of the first MC-LAG; and
in response to detecting the failure, performing an ICR switchover by:
transitioning to serving as the standby ICR device of the ICR system, and
sending a notification of the ICR switchover to the second network device, causing the second network device to transition to serving as the active ICR device of the ICR system, and further causing the second network device to activate the standby session and use the activated session to carry traffic without having to negotiate with the first client device.

12. The non-transitory machine-readable storage medium of claim 9, wherein sending the session information associated with the first session to the second network device comprises:
storing the session information associated with the first session in a distributed database system (DDS), wherein the DDS is configured to provide an indication, wherein the indication comprises of at least one of an indication that the session information has been sent to a peer ICR device, an indication that the session information has been received by a DDS at the peer ICR device, and an indication that the session information has been sent by the DDS at the peer device to a session daemon at the peer ICR device.

13. A method in a first network device of an inter-chassis redundancy (ICR) system that is communicatively coupled to a second network device of the ICR system, wherein the first network device configured to serve as a standby ICR device of the ICR system is communicatively coupled to a third network device via a second link, and wherein the second network device configured to serve as an active ICR device of the ICR system is communicatively coupled to the third network device via a first link, wherein the first link and the second link belong to a first multi-chassis link aggregation group (MC-LAG), and wherein the third network device is communicatively coupled to a plurality of client devices, the method comprising:
receiving from the second network device session information associated with a first session, wherein the first session is used by the second network device for exchanging traffic with a first client device of the plurality of client devices; and
using the received session information to create a standby session corresponding to the first session.

14. The method of claim 13, further comprising:
receiving a notification from the second network device indicating the second network device has performed an ICR switchover; and
in response to receiving the notification, performing an ICR switch over by:
transitioning to serving as the active ICR device of the ICR system,
activating the standby session, and
using the activated standby session to carry traffic without having to negotiate with the first client device.

15. The method of claim 13, further comprising:
storing the received session information associated with the first session in a distributed database system (DDS), wherein the DDS is configured to provide an indication, wherein the indication comprises of at least one of an indication that the session information has been received and an indication that session information has been sent to a session daemon at the first network device.

16. A first network device of an inter-chassis redundancy (ICR) system that is communicatively coupled to a second network device of the ICR system, wherein the first network device configured to serve as a standby ICR device of the ICR system is communicatively coupled to a third network device via a second link, and wherein the second network device configured to serve as an active ICR device of the ICR system is communicatively coupled to the third network device via a first link, wherein the first link and the second link belong to a first multi-chassis link aggregation group (MC-LAG), and wherein the third network device is communicatively coupled to a plurality of client devices, the first network device comprising:
a set of one or more processors; and
a non-transitory machine-readable storage medium containing code, which when executed by the set of one or more processors, causes the first network device to:
receive from the second network device session information associated with a first session, wherein the first session is used by the second network device for exchanging traffic with a first client device of the plurality of client devices, and
use the received session information to create a standby session corresponding to the first session.

17. The first network device of claim 16, wherein the non-transitory machine-readable storage medium further contains code, which when executed by the set of one or more processors, causes the first network device to:
receive a notification from the second network device indicating the second network device has performed an ICR switchover; and
in response to receiving the notification, perform an ICR switch over by:
transitioning to serving as the active ICR device of the ICR system,
activating the standby session, and
using the activated standby session to carry traffic without having to negotiate with the first client device.

18. The first network device of claim 16, wherein the non-transitory machine-readable storage medium further contains code, which when executed by the set of one or more processors, causes the first network device to:
store the received session information associated with the first session in a distributed database system (DDS), wherein the DDS is configured to provide an indication, wherein the indication comprises of at least one of an indication that the session information has been received and an indication that session information has been sent to a session daemon at the first network device.

19. A non-transitory machine-readable storage medium having computer code stored therein, which when executed by a set of one or more processors of a first network device of an inter-chassis redundancy (ICR) system that is communicatively coupled to a second network device of the ICR system, wherein the first network device configured to serve as a standby ICR device of the ICR system is communicatively coupled to a third network device via a second link, and wherein the second network device configured to serve as an active ICR device of the ICR system is communicatively coupled to the third network device via a first link, wherein the first link and the second link belong to a first multi-chassis link aggregation group (MC-LAG), and wherein the third network device is communicatively coupled to a plurality of client devices, causes the first network device to perform operations comprising:
receiving from the second network device session information associated with a first session, wherein the first session is used by the second network device for exchanging traffic with a first client device of the plurality of client devices; and
using the received session information to create a standby session corresponding to the first session.

20. The non-transitory machine-readable storage medium of claim 19, further comprising:
receiving a notification from the second network device indicating the second network device has performed an ICR switchover; and
in response to receiving the notification, performing an ICR switch over by:
transitioning to serving as the active ICR device of the ICR system,
activating the standby session, and
using the activated standby session to carry traffic without having to negotiate with the first client device.

21. The non-transitory machine-readable storage medium of claim 19, further comprising:
storing the received session information associated with the first session in a distributed database system (DDS), wherein the DDS is configured to provide an indication, wherein the indication comprises of at least one of an indication that the session information has been received and an indication that session information has been sent to a session daemon at the first network device.
